(19) United States
(12) Patent Application Publication
(10) Pub. No.: US 2012/0305037 A1
(43) Pub. Date: Dec. 6, 2012

(54) SPRAYING ARM ASSEMBLY FOR A CLEANING MACHINE FOR A MULTI-RACK TROLLEY OF A CLEANING MACHINE

(76) Inventors: Samo PETRIC, Stari trg pri Lozu (SI); Erich AMMANN, Eschenbach (CH)

(21) Appl. No.: 13/295,201

(22) Filed: Nov. 14, 2011

(30) Foreign Application Priority Data
Nov. 12, 2010 (DE) 102010051200.1-15

(51) Int. Cl. B08B 3/00

(52) U.S. Cl. 134/198

(57) ABSTRACT

A spraying arm assembly for a trolley (1) for holding objects to be cleaned, which trolley can be introduced into the spraying compartment of a cleaning machine for utensils placed on individual tiered racks: rotatable spraying arms (3) are assigned individually to each rack. The arms have outlet openings (31, 32, 33), from which spraying-liquid jets can be directed onto the utensils. Individual spraying arms (3) are attached one above the other to a central support post (2), which is rotatably supported. The spraying liquid is introduced into an interior space of the support post (2), and interior spaces of the individual spraying arms are connected to the interior space of the support post (2).

The invention pertains to a spraying arm assembly for a trolley for holding objects to be cleaned, which trolley can be introduced into the spraying compartment of a cleaning machine for cleaning medical, pharmaceutical, and/or laboratory utensils, which are to be placed on the individual tiered racks of the trolley.

Trolleys for holding objects to be cleaned, which can be introduced into the spraying compartment of a cleaning machine like dishwashers or machines for cleaning medical, pharmaceutical, and/or laboratory utensils, are known, wherein the term “cleaning” is intended to include the treatment of the individual utensils or objects with a washing liquid, a spraying liquid, and possibly drying air. These trolleys which hold the objects to be cleaned usually comprise several levels or racks arranged one above the other, in which the objects to be cleaned can be placed, either in baskets or directly on the racks, wherein each of these racks is assigned at least one spraying arm, which can rotate around a vertical rotational axis, which simultaneously serves to supply a fluid medium such as spraying liquid or drying air by way of channels, which, when the trolley holding the objects to be cleaned is introduced into the spraying compartment, become connected to a supply and distribution device arranged in the spraying compartment. By aiming the jets of fluid medium emerging from the spraying arms in the appropriate direction, the spraying arms can be driven around their rotational axis. Supplying and distributing the fluid medium separately to each spraying arm results in considerable flow resistances and also to sealing problems both between the distributor in the spraying compartment and the trolley and also between the channels in the trolley and the rotating spraying arms.

The invention is based on the goal of creating a spraying arm assembly of the type described above which results in a significant simplification of the rotary drive of the spraying arms and in an increase in its reliability.

This goal is achieved by the features given in claim 1.

Advantageous embodiments and elaborations of the invention can be derived from the subclaims.

Because the individual spraying arms are attached one above the other to a central support post, sealed rotary bearings must be provided only at the ends of the support post. Sealing problems are thus significantly reduced, and each spraying arm contributes to the force which rotates the common support post and thus the spraying arms.

Because a rotary bearing which is leak-tight with respect to the fluid medium must be provided only at the ends of the support post and not on each of the individual spraying arms, the design of the spraying arm assembly, i.e., of the trolley for holding the objects to be cleaned, is greatly simplified, and the drive force is transmitted more efficiently to the spraying arm assembly.

The support post is preferably supplied with the fluid medium from only one end, but it could also be supplied from both ends, if desired. In either case, the devices installed in the spraying compartment to supply each of the spraying arms with the fluid medium are simplified, because there is no longer any need for complicated distributors or separate rotary bearings for each spraying arm.

According to one embodiment, the support post comprises individual pairs of diametrically opposed radial connection openings for the attachment of the individual halves of a spraying arm. In the area of these connection openings for the spraying arms, throttle elements are preferably provided in the interior of the support post, namely, downstream from these connection openings; these throttle elements have the effect of distributing the pressure uniformly over the spraying arms tiered on their various levels.

These throttle elements can comprise bevels at the ends adjacent to the connection openings for the spraying arms 3 to deflect the spraying liquid conducted through the support post into the spraying arms.

According to a preferred embodiment of the invention, the rotary bearings of the support post are formed by inner bearing rings, which are mounted in a torque-proof manner on the upper and lower ends of the support post, and by outer bearing bushes, in which the inner bearing rings are rotatably supported and which are fastened to the upper and lower racks of the trolley.

The inner bearing rings preferably comprise a labyrinth seal on their outer circumference, which produces a sealing action against the assigned outer bearing bush of the trolley.

At least one of the lower and/or the upper outer bearing bush can form part of a coupling device for establishing a connection with a coupling arrangement in the spraying compartment of the cleaning machine for supplying spraying liquid.

The invention is explained in greater detail below on the basis of the exemplary embodiments illustrated in the drawings:

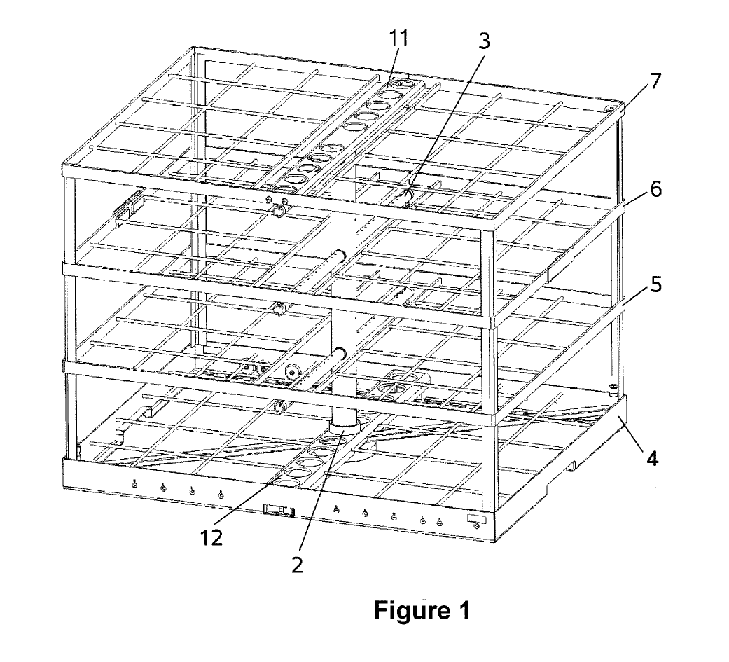

FIG. 1 shows a perspective view of one embodiment of a trolley for holding objects to be cleaned with one embodiment of the spraying arm assembly;

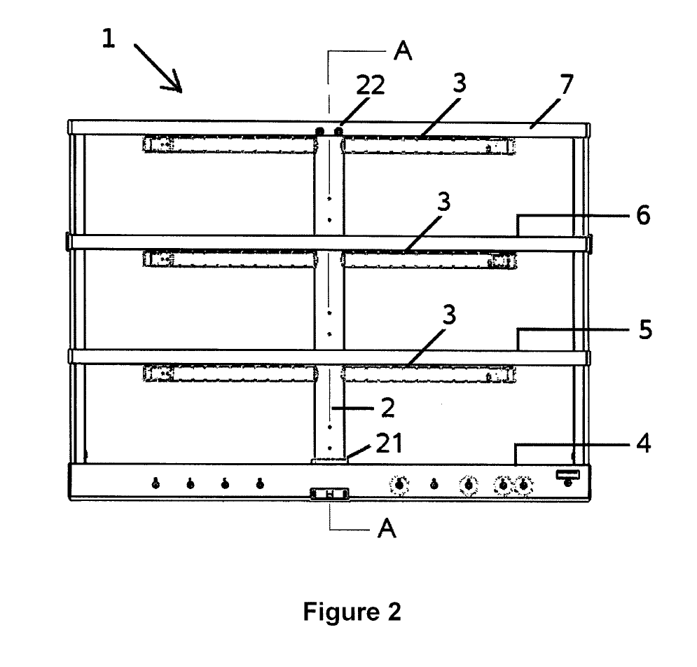

FIG. 2 shows a schematic diagram of the front of the trolley for holding the objects to be cleaned according to FIG. 1;

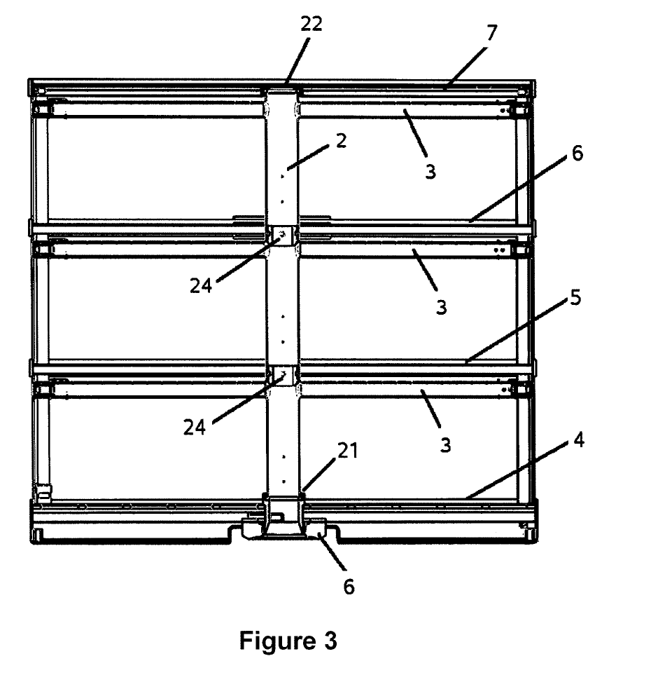

FIG. 3 shows a cross-sectional view along line A-A of FIG. 2, looking in the direction of the arrows;

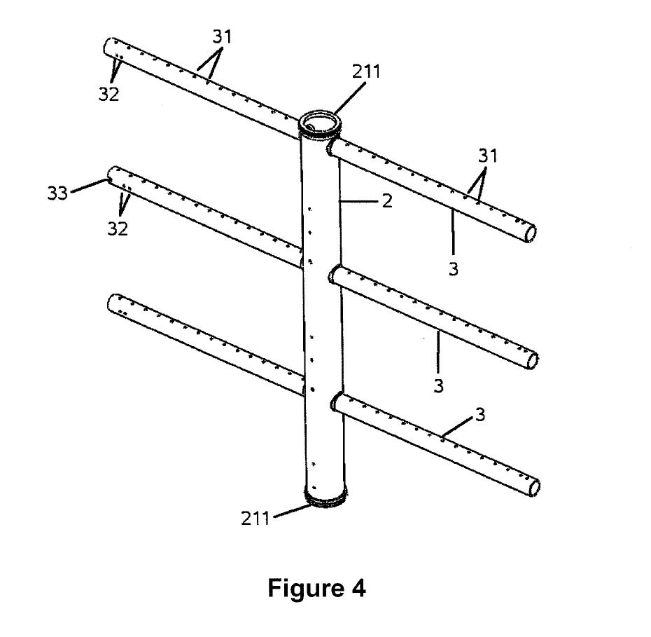

FIG. 4 shows a view of an embodiment of the spraying arm assembly;

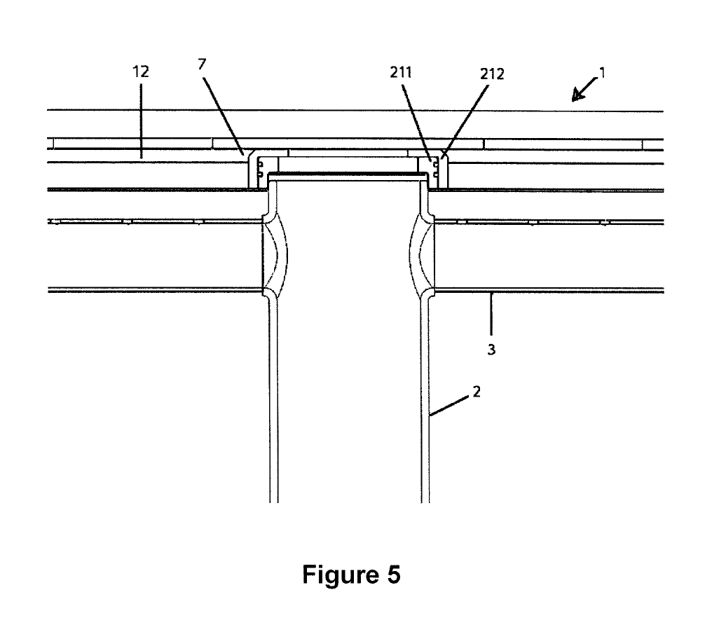

FIG. 5 shows a cross-sectional view of the upper bearing of the support post of the spraying arm assembly according to FIG. 4;

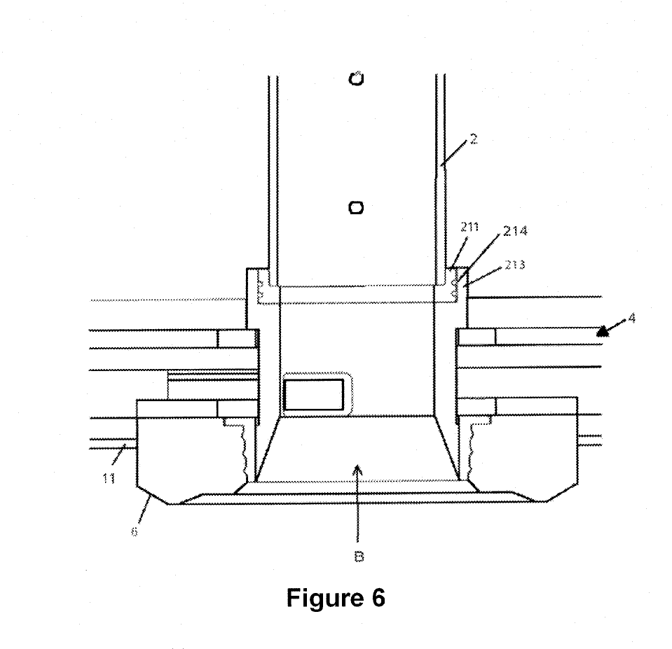

FIG. 6 shows a cross-sectional view of the lower bearing of the support post of the spraying arm assembly according to FIG. 4;

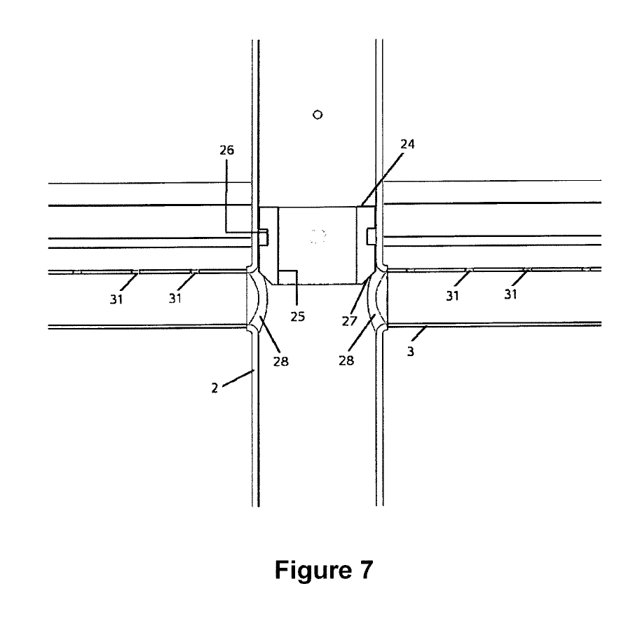

FIG. 7 shows a cross-sectional view of one embodiment of the support post with a throttle element installed therein; and

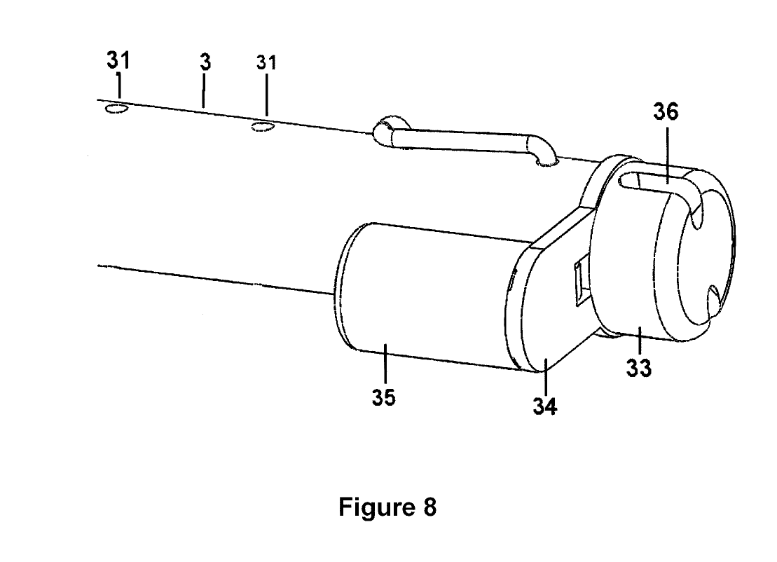

FIG. 8 shows a detailed view of one embodiment of the free end of a spraying arm.

FIG. 1 shows a schematic diagrams of a trolley 1 for holding the objects to be cleaned, which can be introduced or pushed into a receiving compartment of a cleaning and/or disinfecting and/or drying machine (“cleaning machine” below) for the treatment of medical, pharmaceutical, and/or laboratory utensils. This trolley 1 comprises several shelves or racks 4, 5, 6, 7, which are tiered one above the other and provided with appropriate support surfaces for the baskets used to hold the objects to be cleaned or for the objects to be cleaned themselves.

Several spraying arms 3 are rotatably installed in the interior of this trolley 1; they are fastened to a central support post 2, the upper and lower ends of which are rotatably attached to upper and lower racks of the trolley 1, as can be seen especially clearly in FIGS. 2 and 3. In the embodiment shown here, the support post 2 is sealed off at its upper end, whereas its lower end is open, thus making it possible for spraying or rinsing liquid or drying air to be supplied. The individual spraying arms 3 are fastened to this support post 2 symmetrically with respect to each other, and the ends which face the support post are connected to the interior of the support post 2 by way of connection openings, so that, in the case of the embodiment shown here, spraying liquid or drying air fed into the support post 2 from below can flow into the interiors of the spraying arms 3. The spraying arms 3 are sealed off at their ends and comprise outlet openings 31 along their length, from which the spraying liquid or drying air can emerge.

So that the fluid medium such as the spraying or rinsing liquid or the drying air can be distributed uniformly over the individual tiered spraying arms 3 even though the spraying arms are located at different heights, throttle elements 24 are arranged in the interior of the support post in the manner shown in FIGS. 3 and 7. These elements constrict the cross section of the support post 2, and at the same time they make it possible to divert the fluid medium into the individual support posts.

These throttle elements 24 are ring-shaped and, in the manner shown especially clearly in FIG. 7, comprise an inner cross section 24 which, in accordance with the position of the throttle elements 24 in the support post, makes it possible to distribute the flow of fluid appropriately to the individual spraying arms 3. At the ends adjacent to the connection openings 28 in the support post 2, the throttle elements 24 comprise bevels 27, which improve the deflection of the fluid medium into the interiors of the spraying arms 3.

The support post 2 can also be provided with outlet openings for the fluid medium, so that, as the support post rotates, jets of the fluid medium can also be directed through these openings at the objects arranged on the individual racks.

In addition to the outlet openings 31 aiming essentially upward and downward (not shown), the spraying arms 3 are also provided at their ends with essentially horizontally oriented outlet openings 32, 33, wherein the jets of fluid medium emerging from these openings produce a force which drives spraying min assembly consisting of the support post 2 and the spraying arms 3 around the center axis of the support post 2.

At the otherwise closed freed ends of the spraying arms 3, outlet openings 33 can also be provided, which have the effect of cleaning the spraying compartment and/or contribute to the force which drives the spraying arm assembly.

FIGS. 5 and 6 show details of the upper and lower bearings of the support post 2. On the upper and lower ends of the tubular support post, inner bearing rings 211 are mounted, which consist, for example, of a plastic with good sliding properties, the outer surface 214 of which serves as a labyrinth seal, designated schematically in FIG. 6 by the reference number 212, to seal off the ends of the support post 2 against the outer bearing bushes 212, 213, which are fastened to the upper and lower transverse struts 11, 12 of the trolley 1.

As shown in FIG. 6, the lower end of the support post 2 is supported in the interior of an outer bearing bush 213 by its inner bearing ring 211, which is mounted on the post. The outer bearing bush is fastened to the lower transverse strut 12 of the trolley 1. This outer bearing bush 213 extends down into a coupling element 6, which . . . with a cooperating coupling element (not shown) in the spraying compartment of the cleaning machine, wherein a fluid-tight coupling is produced when the trolley 1 is pushed into the spraying compartment.

In this way, a fluid medium can be introduced from the spraying chamber of the machine into the bottom end of the support post 2 and distributed by this support post 2 over the individual spraying arms 3. In place of or in addition to the introduction of the fluid medium into the support post 2 from below, it is also possible to introduce the fluid medium into the support pipe from above.

Because the individual spraying arms 2 on the individual racks or racks of the trolley 1 are mounted on and supplied through a common support post 2, the design of the trolley 1 is greatly simplified, because there is no longer any need to provide separate bearings for the spraying arms or devices for supplying the fluid medium to these spraying arms on each individual shelf or rack of the trolley.

Because only an upper bearing and a lower bearing are provided on the support post, furthermore, the friction of the overall spraying arm assembly is reduced, which means that these spraying arms can rotate more easily at a given fluid medium pressure. The essentially horizontally oriented outlet openings 32 of the spraying arms 3, furthermore, all contribute to the force which drives the spraying arm assembly.

Both the support post 2 and also the individual spraying arms 3 can be made out of tubing with a circular cross section, and the spraying half-arms can be welded to the support post and closed off at their free ends by sealing caps, which simplifies the fabrication of the spraying arm assembly.

As shown in FIG. 8, the free ends of the spraying arms 3 can be closed off by end caps 33, in which additional outlet openings or nozzles 36 are arranged in such a way that jets of spraying liquid are produced in the shape of fans, for example, which extend in the longitudinal direction of the spraying arms 3 and also vertically upward from them.

Holders 34 for at least one magnet 35 can also be arranged on the end caps 32 of at least one of the spraying arms in such a way that the at least one magnet 35 is axially offset from the longitudinal axis of the spraying arm, wherein the magnets cooperate with stationary magnetic sensors to monitor the rotation of the spraying arm 3.

Although, in the embodiment of the spraying arms which can be seen especially clearly in FIG. 4, the outlet openings 31 are arranged with a vertical orientation in a line extending along the length of the spraying arm, these openings in the individual spraying half-arms can also be arranged along a line which is at an angle to the vertical diameter of the spraying arm 3, so that the outlet openings 31 also contribute to the rotational force acting on the spraying arm assembly formed by the spraying arms 3 and the support post 2.

In another embodiment, the openings 31 in the two halves of the spraying arm can, when looked at from one end of the spraying arm 3, be arranged along a line which is offset from a vertical diameter of the spraying arm 3 by the same predetermined angle in both halves, so that, when the spraying arm rotates around 180°, the orientation of the jets shifts back and forth, thus improving the spraying action on the objects arranged on the individual racks or racks.

The latter is possible because of the presence of the additional outlet openings 32, 33, which produce the primary force which drives the spraying arms 3 around the center axis of the support post 2.

1. A spraying arm assembly for a trolley for holding objects to be cleaned, which trolley can be introduced into the spraying compartment of a cleaning machine for cleaning medical, pharmaceutical, and/or laboratory utensils, which are arranged on the individual tiered racks of the trolley, wherein the spraying arm assembly comprises spraying arms, which are assigned individually to each rack, which can rotate around a vertical rotational axis, which comprise interior spaces supplied with spraying liquid from the rotational axis, and which are provided with outlet openings, from which spraying-liquid jets
the individual spraying arms are attached, one vertically above the other, to a central support post, which is rotatably supported at its ends in rotary bearings on the lower and upper racks of the trolley; in that
the spraying liquid is introduced into an interior space of the support post through at least one end thereof; and in that
the interior spaces of the individual spraying arms are in fluid-flow connection with the interior space of the support post.

2. A spraying arm assembly according to claim 1, wherein the support post comprises individual pairs of diametrically opposed, radial connection openings for the attachment of the individual halves of a spraying arm, and in that, in the area of the connection openings for the spraying arms, throttle elements, which ensure a uniform pressure distribution over the spraying arms arranged on the individual tiered racks, are installed in the interior space of the support post.

3. A spraying arm assembly according to claim 2, wherein at the ends adjacent to the connection openings for the spraying arms, the throttle elements comprise bevels for deflecting the spraying liquid conducted through the support post into the spraying arms.

4. A spraying arm according to claim 2, wherein the outside circumference of the throttle elements is sealed off against the inside wall of the support post, and in that the throttle elements comprise a central through-opening.

5. A spraying arm assembly according to claim 1, wherein the rotary bearings are formed by inner bearing rings, mounted in a torque-proof manner on the upper and lower ends of the support post, and outer bearing bushes, in which the inner bearing rings are rotatably supported, and which are fastened to lower and upper racks of the trolley.

6. A spraying arm assembly according to claim 5, wherein the inner bearing rings form, on their outer circumference, a labyrinth seal, which forms a seal against the associated outer bearing bush on the trolley.

7. A spraying arm assembly according to claim 5, wherein at least one of the lower and upper outer bearing bushes forms part of a coupling device for establishing a connection with a coupling arrangement provided in the spraying compartment of the cleaning machine for supplying spraying liquid.

8. A spraying arm according to claim 1, wherein the free ends of the spraying arms are closed off by end caps.

9. A spraying arm according to claim 8, wherein holders for at least one magnet are arranged on the end caps in such a way that the at least one magnet is axially offset from the longitudinal axis of the spraying arm, and in that the magnets cooperate with stationary magnetic sensors to monitor the rotation of the spraying arm.

10. A spraying arm assembly according to claim 1, wherein the spraying liquid is can be replaced in program-controlled fashion by a rinsing liquid and/or drying air.
